(19) United States
(12) Patent Application Publication
(10) Pub. No.: US 2026/0302845 A1
(43) Pub. Date: Oct. 1, 2026

(54) STATOR BUSHING

(71) Applicant: Schaeffler Technologies AG & Co. KG, Herzogenaurach (DE)

(72) Inventors: Christopher Chapanar, Massillon, OH (US); Kyle Nelson, Delaware, OH (US)

(73) Assignee: Schaeffler Technologies AG & Co. KG, Herzogenaurach (DE)

(21) Appl. No.: 19/630,608

(22) Filed: Mar. 27, 2026

Related U.S. Application Data
(60) Provisional application No. 63/779,854, filed on Mar. 28, 2025.

(51) Int. Cl. H02K 1/18; H02K 15/40

(52) U.S. Cl. CPC H02K 1/18; H02K 15/40

(57) ABSTRACT

An electric motor includes a nonrotatable stator, a housing, a cover, a bushing and a bolt. The stator has an axially extending hole and a first planar surface, and the housing has a threaded hole. The cover has a through hole with a circumferential surface. The bushing contacts the circumferential surface and the first planar surface, and the bolt extends through the bushing and the axially extending hole, and is threaded into the threaded hole. A method of securing a nonrotatable stator for an electric motor to a housing for the electric motor is also disclosed.

### CROSS-REFERENCE TO RELATED APPLICATIONS

This application claims the benefit of U.S. Provisional Patent Application No. 63/779,854, filed March 28, 2025, the disclosure of which is incorporated in its entirety by reference herein.

### TECHNICAL FIELD

The present disclosure relates generally to fixing a stator in a housing, and more specifically to a stator bushing for improved fixing of the stator in the housing.

### BACKGROUND

Bolting a stator to a housing is known. One example is shown and described in Chinese Utility Model Patent No. CN 219247604 U, titled 一种驱动电机及机动车 (Drive motor and motor vehicle) to Zhejiang Lingyi Power Technology Co., Ltd.

### SUMMARY

Example embodiments broadly comprise an electric motor including a nonrotatable stator, a housing, a cover, a bushing and a bolt. The stator has an axially extending hole and a first planar surface, and the housing has a threaded hole. The cover has a through hole with a circumferential surface. The bushing contacts the circumferential surface and the first planar surface, and the bolt extends through the bushing and the axially extending hole, and is threaded into the threaded hole. In an example embodiment, the nonrotatable stator has a plurality of stacked plates, each with a plate hole, and the axially extending hole is formed by the plate holes. In an example embodiment, the axially extending hole extends through the first planar surface.

In an example embodiment, the housing is L-shaped in cross-section and at least partially surrounds the nonrotatable stator. In an example embodiment, the bolt has a bolt head contacting the bushing. In an example embodiment, there is a radial clearance between the bolt and the axially extending hole. In some example embodiments, the stator has a second planar surface contacting the housing. In an example embodiment, the axially extending hole extends through the second planar surface. In an example embodiment, the bushing is a tubular bushing.

Other example embodiments broadly comprise a method of securing a nonrotatable stator for an electric motor to a housing for the electric motor. The method includes providing the nonrotatable stator having an axially extending hole and a first planar surface, providing the housing having a threaded hole and providing a cover with a through hole having a circumferential surface. The method also includes installing a bushing in the through hole, installing a bolt in the bushing and the axially extending hole, and fixing the nonrotatable stator to the housing by threading the bolt into the threaded hole so that the bushing contacts the circumferential surface and the first planar surface.

In an example embodiment, the method includes fixing the cover to the housing. In some example embodiments, the bushing has a radial clearance to the circumferential surface before the nonrotatable stator is fixed to the housing. In an example embodiment, the threading the bolt into the threaded hole radially expands the bushing to contact the circumferential surface. In an example embodiment, the threading the bolt into the threaded hole includes tightening the bolt to a predetermined torque.

### BRIEF DESCRIPTION OF THE DRAWINGS

FIG. 1 illustrates schematic cross-sectional view of a portion of an electric motor according to an example embodiment.

FIG. 2 illustrates an embodiment of the electric motor of FIG. 1 shown before assembly of a bolt.

FIG. 3 illustrates the embodiment of FIG. 2 shown after assembly of the bolt.

### DETAILED DESCRIPTION

Embodiments of the present disclosure are described herein. It should be appreciated that like drawing numbers appearing in different drawing views identify identical, or functionally similar, structural elements. Also, it is to be understood that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The terminology used herein is for the purpose of describing particular aspects only, and is not intended to limit the scope of the present disclosure. Unless defined otherwise, all technical and scientific terms used herein have the same meaning as commonly understood to one of ordinary skill in the art to which this disclosure belongs. Although any methods, devices or materials similar or equivalent to those described herein can be used in the practice or testing of the disclosure, the following example methods, devices, and materials are now described.

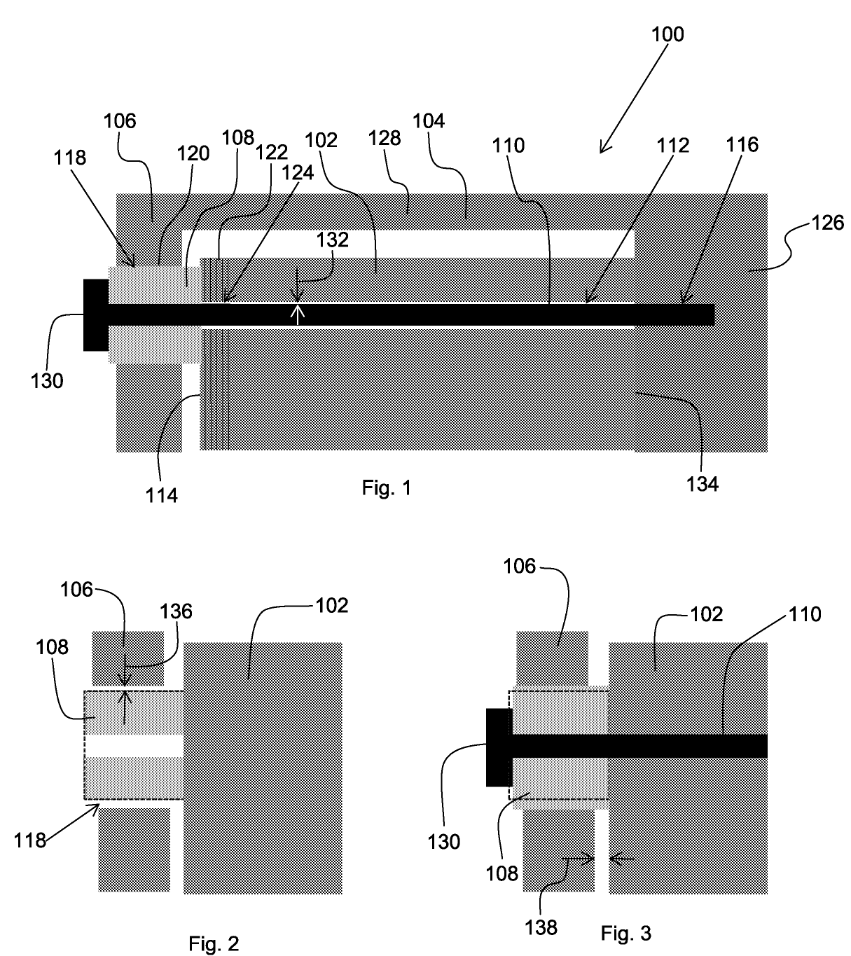

The following description is made with reference to FIG. 1. FIG. 1 illustrates schematic cross-sectional view of a portion of electric motor 100. The portion shown may be a stator assembly that surrounds a rotatable rotor assembly (not shown) in a known manner. Electric motor 100 includes nonrotatable stator 102, housing 104, cover 106, bushing 108 and bolt 110. The stator includes axially extending hole 112 and planar surface 114. Housing 104 includes threaded hole 116. Cover 106 comprises through hole 118 having circumferential surface 120. Bushing 108 contacts the circumferential surface and planar surface 114, and the bolt extends through the bushing and the axially extending hole, and is threaded into the threaded hole.

Nonrotatable stator 102 includes a plurality of stacked plates 122, and each of the stacked plates has a plate hole 124. In other words, stator 102 is formed from laminations. Axially extending hole 112 is formed by plate holes 124 and extends through planar surface 114. As shown in FIG. 1, for example, the housing is L-shaped in cross-section and surrounds the nonrotatable stator. That is, the housing is formed from annular portion 126 and cylindrical portion 128 that surrounds the stator. Bolt 110 includes bolt head 130 contacting the bushing, and there is radial clearance 132 between the bolt and the axially extending hole. Stator 102 includes planar surface 134 contacting the housing. Axially extending hole 112 extends through planar surface 134. Bushing 108 is a tubular bushing.

The following description is made with reference to FIGS. 1-3. FIG. 2 illustrates an embodiment of the electric motor of FIG. 1 shown before assembly of bolt 110. FIG. 3 illustrates the embodiment of FIG. 2 shown after assembly of the bolt.

A method of securing nonrotatable stator 102 for electric motor 100 to housing 104 will now be described. The method includes providing stator 102, housing 104, and cover 106. As discussed above, stator 102 includes axially extending hole 112 and planar surface 114, and cover 106 includes through hole 118 with circumferential surface 120. The method also includes installing bushing 108 in the through hole, installing bolt 110 in the bushing and the axially extending hole, and fixing the stator to the housing by threading the bolt into the threaded hole so that bushing 108 contacts circumferential surface 120 and planar surface 114. Bushings may be press-fit into the cover or installed as a tight slip-fit with minimal radial clearance and expanded as described below. The method also includes fixing the cover to the housing,

As shown in FIG. 2, for example, in some embodiments, the bushing has radial clearance 136 to the circumferential surface before the nonrotatable stator is fixed to the housing, and threading the bolt into the threaded hole radially expands the bushing to contact the circumferential surface. Clearance 136 is shown exaggerated in FIG. 2, and would likely be almost imperceivable as the fit between the bushing and the hole is a tight, slip fit. Threading the bolt into the threaded hole includes tightening the bolt to a predetermined torque. In other words, the bushing fits loosely into the cover holes and compression between the bolt head and the stator axially shortens and radially expands the bushing (as shown by the dashed lines in FIG. 3, for example) to fit tightly in the cover hole to provide radial support to the stator near the cover without overconstraining the assembly. This eliminates a possibility of overconstraint by fixation on both ends that could present a gap or interference between the housing or the cover and the stator when manufacturing tolerances are considered. Axial gap 138 between the cover and stator after assembly assures that only the bushing positions the stator in the housing.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

### REFERENCE NUMERALS

100 Electric motor

102 Stator

104 Housing

106 Cover

108 Bushing

110 Bolt

112 Axially extending hole

114 Planar surface (stator, first)

116 Threaded hole (housing)

118 Through hole (cover)

120 Circumferential surface (through hole)

122 Stacked plates

124 Plate hole

126 Annular portion (housing)

128 Cylindrical portion (housing)

130 Bolt head

132 Radial clearance (bolt to axially extending hole)

134 Planar surface (stator, second)

136 Radial clearance (bushing to through hole)

138 Axial gap (cover to stator)

What is claimed is:

1. An electric motor, comprising:
a nonrotatable stator comprising:
an axially extending hole; and
a first planar surface;
a housing comprising a threaded hole;
a cover comprising a through hole, the through hole comprising a circumferential surface;
a bushing contacting the circumferential surface and the first planar surface; and
a bolt extending through the bushing and the axially extending hole, and threaded into the threaded hole.

2. The electric motor of claim 1, wherein:
the nonrotatable stator comprises a plurality of stacked plates, each comprising a plate hole; and
the axially extending hole is formed by the plate holes.

3. The electric motor of claim 1, wherein the axially extending hole extends through the first planar surface.

4. The electric motor of claim 1, wherein the housing is L-shaped in cross-section and at least partially surrounds the nonrotatable stator.

5. The electric motor of claim 1, wherein the bolt comprises a bolt head contacting the bushing.

6. The electric motor of claim 1, wherein there is a radial clearance between the bolt and the axially extending hole.

7. The electric motor of claim 1, wherein the stator comprises a second planar surface contacting the housing.

8. The electric motor of claim 7, wherein the axially extending hole extends through the second planar surface.

9. The electric motor of claim 1, wherein the bushing is a tubular bushing.

10. A method of securing a nonrotatable stator for an electric motor to a housing for the electric motor, comprising:
providing the nonrotatable stator, comprising:
an axially extending hole; and
a first planar surface;
providing the housing, comprising a threaded hole;
providing a cover, comprising a through hole comprising a circumferential surface;
installing a bushing in the through hole;
installing a bolt in the bushing and the axially extending hole; and
fixing the nonrotatable stator to the housing by threading the bolt into the threaded hole so that the bushing contacts the circumferential surface and the first planar surface.

11. The method of claim 10, further comprising fixing the cover to the housing.

12. The method of claim 10, wherein the bushing has a radial clearance to the circumferential surface before the nonrotatable stator is fixed to the housing.

13. The method of claim 12, wherein the threading the bolt into the threaded hole radially expands the bushing to contact the circumferential surface.

14. The method of claim 10, wherein the threading the bolt into the threaded hole includes tightening the bolt to a predetermined torque.
